(19) United States
(12) Patent Application Publication
(10) Pub. No.: US 2018/0257029 A1
(43) Pub. Date: Sep. 13, 2018

(54) Magnesium-Iron Complex oxide for Separating and Purifying Carbon Dioxide and Fabrication Method thereof

(71) Applicant: Institute of Nuclear Energy Research, Atomic Energy Council, Executive Yuan, R.O.C., Taoyuan City (TW)

(72) Inventors: Yu-Ming Su, Taipei (TW); Wei-Chen Huang, New Taipei City (TW); Yu-Lin Kuo, New Taipei City (TW); Jen-Chun Yu, New Taipei City (TW); Ching-Ying Huang, Taoyuan (TW); Yau-Pin Chyou, Taoyuan (TW)

(21) Appl. No.: 15/455,274

(22) Filed: Mar. 10, 2017

(51) Int. Cl. B01D 53/62

(52) U.S. Cl. CPC B01D 53/62; B01D 2251/402; B01D 2251/602

(57) ABSTRACT

A method is provided for making a magnesium(Mg)-iron(Fe) complex oxide. The Mg—Fe complex oxide is used for separating and purifying carbon dioxide (CO₂). The present invention solves the problem of using iron ore in chemical looping combustion. The present invention comprises the following steps: At first, iron ore and magnesium nitrate (Mg(NO₃)₂.6H₂O) are impregnated for reaction. After sieving within a fixed range of size, calcination is processed to obtain the Mg—Fe complex oxide. Not only the problem of using iron ore in chemical combustion loop is effectively solved; but also the whole procedure can be looped for a long time with a high CO₂ conversion rate.

### TECHNICAL FIELD OF THE INVENTION

The present invention relates to an iron-based complex oxide; more particularly, to effectively improving implementation of iron ore used in chemical looping combustion, where a solid carbon dioxide (CO₂) conversion ratio is maintained in the reactions for a long time.

### DESCRIPTION OF THE RELATED ART(S)

Chemical looping combustion is a new technology for separating, storing, and recycling CO₂ without extra cost. The United States Energy Board regards the chemical looping combustion as a technology for capturing CO₂ with potential and energy efficiency. At present, researchers are committed to three major directions, which are the selection and improvement of oxide; the design of reactor; and the capture and re-use of CO₂. Therein, the oxide plays a major role in the chemical looping combustion. For evaluating the oxide, considerations include oxygen-carrying capacity, reaction rate, physical strength, anti-abrasion capability, long-term looping capacity, anti-agglomeration capacity, cost, environmental friendliness, etc. Currently, the frequently-used metal oxides are those of nickel (Ni), iron (Fe), copper (Cu), and manganese (Mn), among which the iron-based oxide is regarded as the most promising. The iron-based oxide has advantages including high oxygen-carrying capacity, good reactivity, high physical strength and low price; but also disadvantage of multiple oxidation states. When the iron-based oxide is processed through a redox reaction, the reduction reaction part is slower. Hence, how to improve the reactivity of the iron-based oxide becomes an important task for the chemical loop combustion.

The iron-based oxide has a variety of oxidation states. Different states have different oxygen-carrying capacities. Therein, ferroferric oxide (Fe₃O₄) has a higher oxygen-carrying capacity and a faster reduction rate; if being converted to an iron oxide (FeO), the oxygen-carrying capacity becomes lower, and the reduction rate is relatively smaller. The iron-based oxide is a cheap and non-toxic material at room temperature and has advantages of high stability and ease of handling at room temperature. However, the agglomeration of particles is severe after loops of reaction at high temperature, which restricts the effectiveness of the chemical looping combustion. Hence, the prior art does not fulfill all users' requests on actual use.

### SUMMARY OF THE INVENTION

The main purpose of the present invention is to provide a magnesium(Mg)—Fe complex oxide to be used in chemical looping combustion, where a stable CO₂ conversion ratio is maintained in the reactions for a long time.

Another purpose of the present invention is to provide an iron-based oxide to be used in chemical looping combustion without adding an inert oxide as a carrier, where the problem of using iron-based oxide in chemical looping combustion is solved, and the use is more efficient.

To achieve the above purposes, the present invention is a method of fabricating an Mg—Fe complex oxide for separating and purifying CO₂, comprising steps of: (a) obtaining a source powder of iron ore and magnesium nitrate (Mg(NO₃)₂.6H₂O), where magnesium nitrate has a concentration of 10˜20 mole percents (mol %); (b) adding deionized water to the source powder to be stayed still for one day at a room temperature to form a mixed solution; (c) drying the mixed solution and sieving the mixed solution within an effective particle size range to form a mixed powder, where the effective particle size range is 0.177˜0.297 millimeters (mm); and (d) processing calcination under an atmosphere containing air to form a power of Mg—Fe complex oxide. Accordingly, a novel method of fabricating a Mg—Fe complex oxide for separating and purifying CO₂ is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the view showing the preferred embodiment according to the present invention;

FIG. 2 is the view showing the X-ray diffraction pattern of the magnesium(Mg)-iron(Fe) complex oxide;

FIG. 3 is the view showing the carbon dioxide (CO₂) conversion ratios of the Mg—Fe complex oxide after the 50 loops of the redox reaction;

FIG. 4 is the view showing the surfaces observed through electron microscopy before and after the redox reactions; and

FIG. 5 is the view showing the bamboo-like structures of the Mg—Fe complex oxide.

### DESCRIPTION OF THE PREFERRED EMBODIMENT

The following description of the preferred embodiment is provided to understand the features and the structures of the present invention.

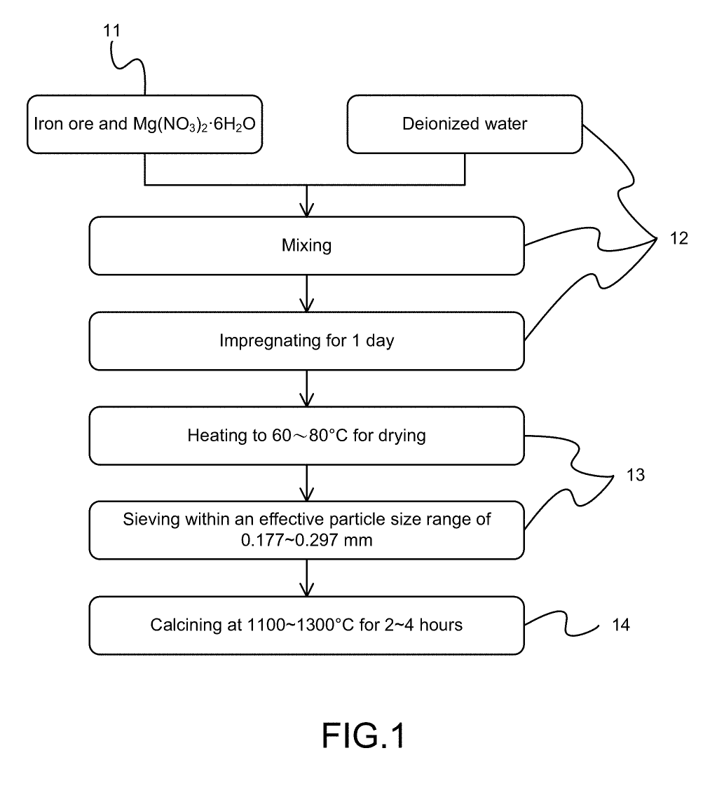

The present invention provides an improved technology. By adding a small amount of metal for modifying an iron-based oxide, iron ore can be effectively used in a chemical combustion loop for significantly enhancing reaction performance. Please refer to FIG. 1, which is a view showing a preferred embodiment according to the present invention. As shown in the figure, the present invention is a method of fabricating a Mg—Fe complex oxide for separating and purifying CO₂, comprising the following steps:

(a) Obtaining source powder 11: A source powder of iron ore and magnesium nitrate (Mg(NO₃)₂.6H₂O) are obtained.

(b) Forming mixed solution 12: Deionized water is added to the source powder to be stayed still at a room temperature for one day to form a mixed solution.

(c) Forming mixed powder 13: The mixed solution is dried and sieved within an effective particle size range to form a mixed powder.

(d) Obtaining final product 14: Calcination is processed under an atmosphere containing air to form a power of Mg—Fe complex oxide.

Thus, a method of fabricating a Mg—Fe complex oxide for separating and purifying CO₂ is obtained.

In step (a), magnesium nitrate added has a concentration of 10˜20 mole percents (mol %). Then, the iron ore powder and the magnesium nitrate powder are mixed with impregnation to be dissolved in deionized water in step (b) and stayed still at a room temperature for one day to form a mixed solution. In step (b), a magnet can be used for constantly stirring until the solution is mixed evenly.

Then, in step (c), the mixed solution is dried and then sieved within an effective particle size range to form a mixed powder. Therein, the mixed solution is placed in an oven and heated to 60˜80 Celsius degrees (° C.) for drying. To be used in a fluidized bed reactor, the effective particle size range for sieving is set at 0.177˜0.297 millimeters (mm). The dried and sieved mixed powder is calcined in step (d). Under an atmosphere containing air, the calcination is processed at a temperature of 1100˜1300° C. for a time of 2˜4 hours. The powder obtained after the calcination is the powder of Mg—Fe complex oxide fabricated according to the present invention.

### State-of-Use 1: Identifying Mg—Fe Complex Oxide Through X-Ray Diffraction

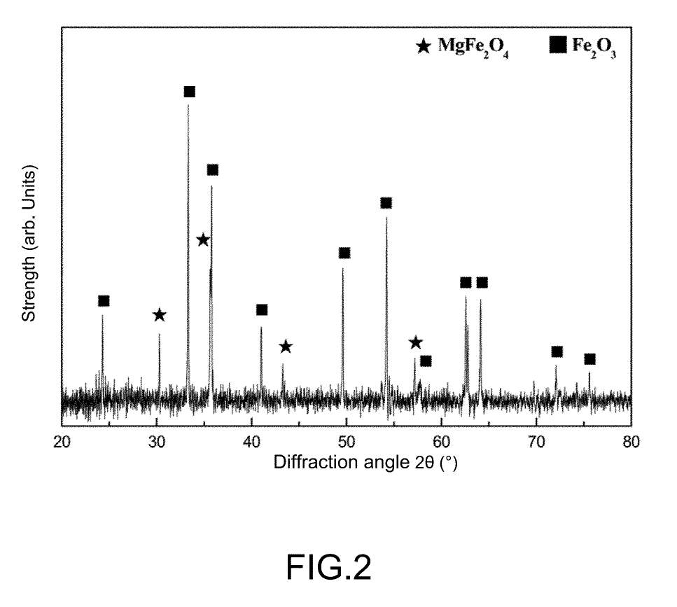

Please further refer to FIG. 2, which is a view showing an X-ray diffraction pattern of a Mg—Fe complex oxide. As shown in the figure, an analysis of an X-ray diffraction result demonstrates that the compositions of the Mg—Fe complex oxide fabricated according to the present invention are a ferric oxide (Fe₂O₃) and magnesium ferrite (MgFe₂O₄), where the magnesium ferrite has a spinel structure.

State-of-Use 2: Testing CO₂ Conversion Rate of Mg—Fe Complex Oxide with Laboratory-Grade Single Fluidized Bed Reactor

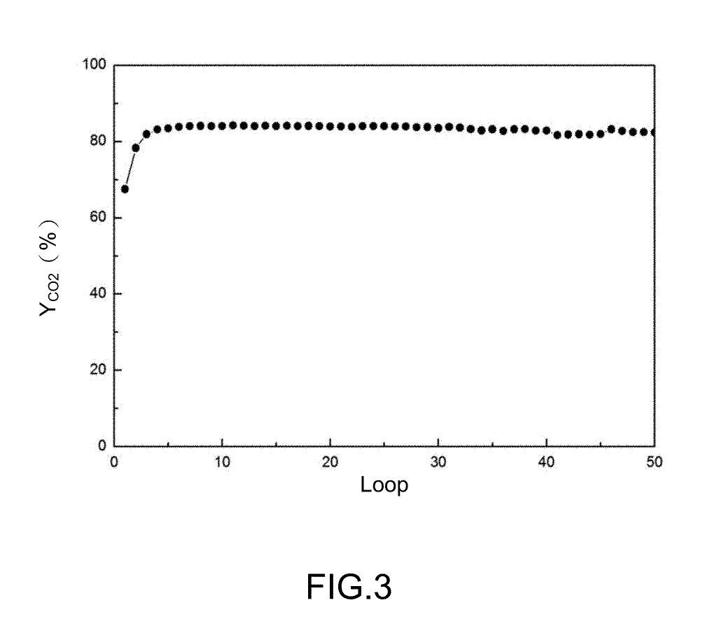

Please further refer to FIG. 3, which is a view showing CO₂ conversion ratios of a Mg—Fe complex oxide after 50 loops of a redox reaction. As shown in the figure, a Mg—Fe complex oxide is processed through redox reactions without adding inert oxide. Carbon monoxide (CO) is introduced as a reducing gas, and the air is introduced as an oxidizing gas. Therein, CO has a composition ratio of 5˜10 percents (%), and the reaction is processed at a temperature of 900° C. As results show, in 50 loops of redox reaction using the Mg—Fe complex oxide, CO₂ concentrations are low in the first 2-3 loops and then are maintained at a constant value. The reason is that the first 2-3 loops are activation reactions for the Mg—Fe complex oxide. After the activation reactions, the Mg—Fe complex oxide can maintain a stable CO₂ conversion ratio of 80˜85% without significant declination in the 50 loops.

### State-of-Use 3: Observing Surfaces Through Electron Microscopy Before and After Redox Reactions

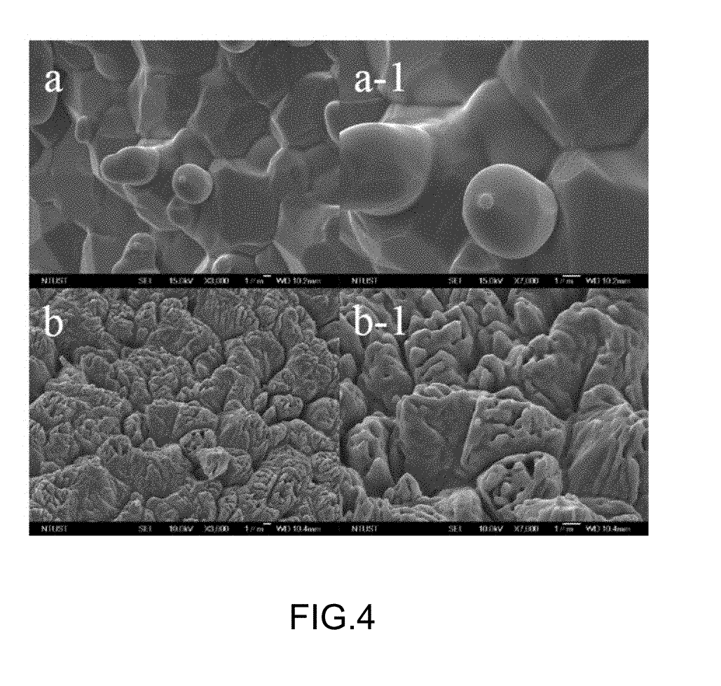

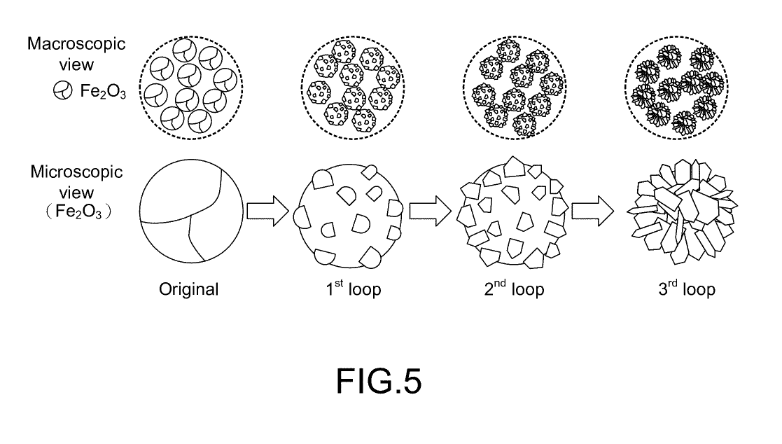

Please further refer to FIG. 4 and FIG. 5, which are a view showing surfaces before and after the 50 loops of redox reactions observed through electron microscopy; and a view showing bamboo-like structures of the Mg—Fe complex oxide. As shown in the figures, surfaces of the Mg—Fe complex oxide formed after redox reactions are analyzed by using electron microscopy (3000× and 7000×). Therein, pictures noting as (a) and pictures noting as (b) are the macroscopic and microscopic surfaces observed through electron microscopy before and after the redox reactions. In the pictures, bamboo-like structures are formed on the surfaces of the Mg—Fe complex oxide after the redox reactions. In FIG. 5, the bamboo-like structures thus formed obtain significant size for the Mg—Fe complex oxide to maintain the good gas-solid reaction. Thus, good reactivity is maintained after the redox reactions for solving the problem of traditional chemical looping combustion of unmodified iron-based oxide. Therein, the problem in the chemical looping combustion is that aggregation may easily happen in the redox reaction to decrease CO₂ conversion ratio.

Thus, the Mg—Fe complex oxide fabricated according to the present invention has the bamboo-like structure formed on the surface to increase the gas-solid reaction between the Mg—Fe complex oxide and air for maintaining a stable CO₂ conversion ratio in reactions for a long time.

To sum up, the present invention is a method of fabricating a Mg—Fe complex oxide for separating and purifying CO₂, where the problem of traditional chemical looping combustion using iron ore is solved for maintaining a high CO₂ conversion ratio within loops of redox reaction for a long time.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a magnesium(Mg)-iron(Fe) complex oxide for separating and purifying carbon dioxide (CO₂), comprising steps of
(a) obtaining a source powder of iron ore and magnesium nitrate (Mg(NO₃)₂.6H₂O),
wherein magnesium nitrate has a concentration of 10˜20 mole percents (mol %);
(b) adding deionized water to said source powder to be stayed still for one day at a room temperature to form a mixed solution;
(c) drying said mixed solution and sieving said mixed solution within an effective particle size range to form a mixed powder, wherein said effective particle size range is 0.177˜0.297 millimeters (mm); and
(d) processing calcination under an atmosphere containing air to form a power of Mg—Fe complex oxide.

2. The method according to claim 1,
wherein, in step (b), said mixed solution is obtained with impregnation.

3. The method according to claim 1,
wherein, in step (c), said mixed solution is dried at a temperature of 60˜80 Celsius degrees (° C.).

4. The method according to claim 1,
wherein, in step (d), said calcination is processed at a temperature of 1100˜1300° C.

5. The method according to claim 1,
wherein, in step (d), said calcination is processed for a time of 2-4 hours.

6. The method according to claim 1,
wherein, in step (d), said Mg—Fe complex oxide comprises a ferric oxide (Fe2O3) and magnesium ferrite (MgFe2O4).

7. The method according to claim 1,
wherein said Mg—Fe complex oxide obtains a bamboo-like structure on a surface through 50 loops of a redox reaction at a high temperature under an atmosphere containing a synthesis gas, and said Mg—Fe complex oxide obtains an increased gas-solid reaction between said synthesis gas and said Mg—Fe complex oxide to maintain a steady CO₂ conversion ratio for a long time.

8. The method according to claim 7,
wherein said high temperature is a temperature of 900° C.±20%.

9. The method according to claim 7,
wherein, in said loops of said redox reaction, air is used in oxidation, carbon monoxide (CO) is used in reduction, and said CO has a composition ratio of 5˜10%.

10. The method according to claim 7,
wherein, after said 50 loops of redox, said CO2 conversion ratio is 80˜85%.
